(19) United States
(12) Patent Application Publication
(10) Pub. No.: US 2005/0060221 A1
(43) Pub. Date: Mar. 17, 2005

(54) Educational product evaluation method and apparatus

(76) Inventors: Bradley D. Kolar, Naperville, IL (US); Beth Marie Ruddock, St. Charles, IL (US)

Correspondence Address: VEDDER PRICE/ACCENTURE, 222 NORTH LASALLE STREET, CHICAGO, IL, 60601, US

(21) Appl. No.: 10/665,179

(22) Filed: Sep. 17, 2003

(51) Int. Cl. G06F 17/60

(52) U.S. Cl. 705/10

(57) ABSTRACT

An educational product evaluation apparatus and method stores business goal rule data and analyzes an educational product based on the stored business goal rule data to determine how an educational product of interest, or a group of educational products of interest, conforms to the business goal rule data and hence strategic objectives of a business organization or other suitable entity. In one embodiment, analysis of the educational product includes generating one or more educational product alignment values for the educational product wherein the educational product alignment value is based on the educational product evaluation category values received, for example, from a learning management system or other source, and based on the stored business goal rule data. An educational product summary, such as a displayed form or printed form or other suitable representation, visually shows an overall business alignment value for each educational product under consideration.

### FIELD OF THE INVENTION

The invention relates generally to learning management apparatus and methods and more particularly to methods and apparatus for evaluating educational products such as educational courses, written materials, or other educational products.

### BACKGROUND OF THE INVENTION

Learning management computer systems are known wherein training professionals may collect information on educational products such as courses being offered for a particular institution, business, or other training entity. Different types of educational products that are offered by corporations and educational entities may includes classroom courses, virtual courses or online training courses. Learning management systems may include databases, for example, that archive the number of participants taking a particular course, evaluation scores provided by such participants for the course and can provide five star ratings based on the evaluation scores.

In addition, such learning management systems may include databases that allow an operator to sort various records containing categories of course evaluation information relating to the educational products. For example, educational product evaluation category information may include course participant ratings for a course, the cost of a course, the number of participants enrolled in a course (e.g., course usage information) and other product category evaluation data. However, conventional learning management systems typically have limited capabilities for determining the overall effectiveness of educational products. For example, decisions on which courses to update, remove from the curriculum, or which courses offer the greatest business value cannot typically be provided. As a result, many corporate training curricula and other institutional curricula may contain courses that are not relevant or cost effective to an organization. In addition, learning management systems do not typically provide a suitable life cycle management technique and as such, curricula can be packed with courses that do not support overall business goals. In addition, known learning management systems may utilize several databases and different interface software must be written to interface with the various databases to obtain and search stored information. Therefore, it is possible to obtain multiple records relating to educational products from different databases and customize a report that shows the multiple categories. However, known management learning systems do not generate a value (e.g., numerical or textual) that takes into account business goals to determine, for example, whether a particular educational product meets desired business goals of an entity. As such, there is typically no indication of any strategic value associated with any particular educational product. Therefore, additional cost and time may be spent navigating and finding a suitable course or groups of courses for a particular subject area. In addition, travel and hotel costs for particular courses may not be delivered as efficiently as necessary.

Accordingly, a need exists for an educational product evaluation system and method that assesses educational products based on alignments with an organization's business goals, such as an organization's strategic goals, or other suitable goals.

### BRIEF DESCRIPTION OF THE DRAWINGS

The present invention is illustrated by way of example and not limitation in the accompanying figures, in which like references numerals indicate similar elements, and in which:

FIG. 1 is a block diagram illustrating one example of an educational product evaluation apparatus in accordance with one embodiment of the invention;

FIG. 2 is a flow chart illustrating one example of an educational product evaluation method in accordance with one embodiment of the invention;

FIG. 3 is a block diagram illustrating, in more detail, an example of an educational product evaluation apparatus in accordance with one embodiment of the invention;

FIG. 4 is a flow chart illustrating one example of an educational product evaluation method in accordance with one embodiment of the invention;

FIG. 5 illustrates one example of an educational product summary in accordance with one embodiment of the invention;

FIGS. 6 and 7 are flow charts illustrating one example of an educational product evaluation method in accordance with one embodiment of the invention;

FIG. 8 illustrates one example of a user input form that facilitates entry of weighting values associated with a plurality of different educational product alignment values;

FIG. 9 is a diagram illustrating one example of a user input form in the form of a presented subject category importance table that visually differentiates each received priority level for each content area of interest in accordance with one embodiment of the invention;

FIG. 10 graphically illustrates one example of a user input form to designate educational product hours for a given educational product across differing content areas and for providing a strategic importance alignment value in accordance with one embodiment of the invention;

FIG. 11 graphically illustrates a business goal rule data user input form for receiving cost threshold data in accordance with one embodiment of the invention;

FIG. 12 illustrates one example of a business goal data user input form for receiving business goal rule data associated with time thresholds for an educational product of interest in accordance with one embodiment of the invention;

FIG. 13 illustrates one example of a displayed graphic pertaining to an educational product cost effectiveness alignment value in accordance with one embodiment of the invention;

FIG. 14 illustrates one example of a displayed graphic pertaining to an educational impact alignment value in accordance with one embodiment of the invention;

FIG. 15 illustrates one example of a displayed graphic pertaining to an overall business alignment value for a particular educational product in accordance with one embodiment of the invention;

FIG. 16 is one example of a displayed graphic pertaining to usage analysis for a plurality of educational products in accordance with one embodiment of the invention;

FIG. 17 illustrates one example of a displayed graphic relating to strategic coverage associated with a plurality of educational products in accordance with one embodiment of the invention; and

FIG. 18 illustrates one example of a displayed graphic illustrating a level of educational product redundancy for a plurality of product subjects in accordance with one embodiment of the invention.

### SUMMARY OF THE INVENTION

Briefly, an educational product evaluation method and apparatus stores business goal rule data and analyzes the educational product based on the stored business goal rule data to determine how an educational product of interest, or a group of educational products of interest, conform to the business goal rule data and hence strategic objectives of a business organization or other suitable entity. In one embodiment, a learning management system, such as a server or other device that has access to or stores multiple category information for an educational product, provides multiple educational product evaluation category values to an educational product analyzer. The educational product analyzer may be, for example, a suitably programmed computer or other device. Business goal rule data is stored in memory, such as in database form or other suitable form, and is accessed by the educational product analyzer to determine whether the educational product of interest complies with designated business goal rule data. The business goal rule data may represent, for example, rules defined for a plurality of desired business goals. In one embodiment, the business goal rule represents a strategic importance level, a cost effectiveness level and an educational product impact level.

In one embodiment, analysis of the educational product includes generating one or more educational product alignment values for the educational product wherein the educational product alignment value is based on the educational product evaluation category values received, for example, from the learning management system or other source, and based on the stored business goal rule data. An educational product summary, such as a displayed form or printed form or other suitable representation, visually shows an overall business alignment value for each educational product under consideration. The overall business alignment value is based on an educational product alignment value, which may include a strategic importance alignment value, a cost effectiveness alignment value, and an educational product impact alignment value. These educational product alignment values are given various weights, such as by a user through a suitable user interface, and the educational product alignment values are combined to provide the overall business alignment value for each educational product of interest. As a result, training curriculum is evaluated with the strategic needs of an organization to allow suitable managing of courses in a particular curriculum on an ongoing basis. As a result, among other advantages, courses that are not useful, cost effective, or strategically relevant to an organization are quickly identified and action can be taken. In addition, repeated evaluation may be used to identify trends and insights concerning training courses or other training assets.

The educational product summary may serve as a type of scorecard that may be used to assess the value of a particular educational product or group of educational products. In addition, since a plurality of educational product evaluation category values are used, such as data relating not only to the cost of a course and the hours of a course, but also participant rating information for a course, as well as the priority level of the course within a content area, are all considered together to provide an overall business alignment value that represents how a particular educational product aligns with business the goal rule data.

### DETAILED DESCRIPTION OF THE PREFERRED EMBODIMENT

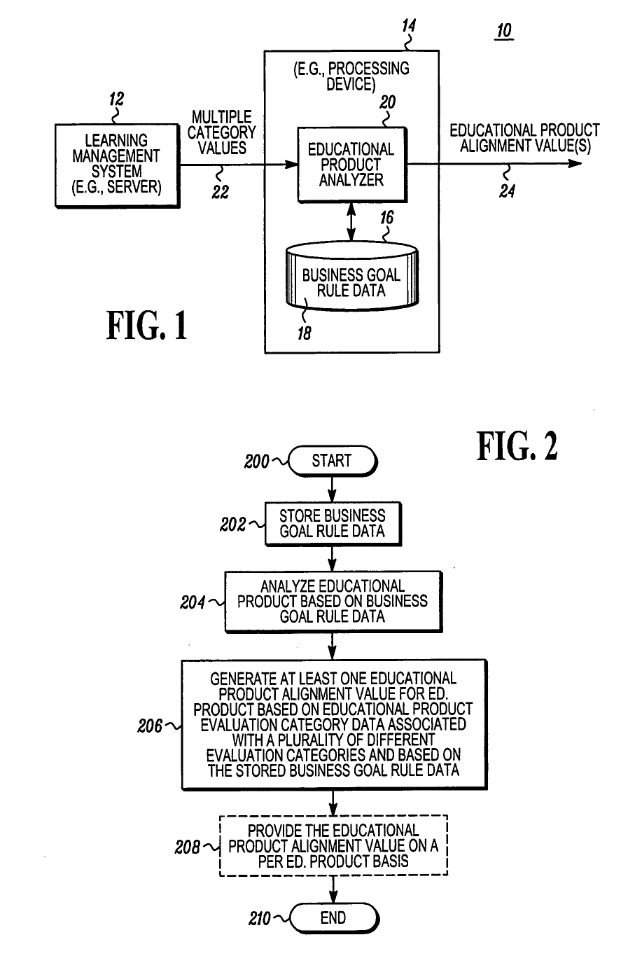

FIG. 1 illustrates one example of an educational product evaluation system 10 that includes a learning management system 12 operatively coupled to an educational product evaluation apparatus 14. The educational evaluation product evaluation system 10 may be implemented as a single computing device or as a plurality of computing devices or in any other suitable manner. For purposes of illustration only, and not limitation, the learning management system 12 will be described as a portion of a computer executing instructions that cause the computer to carry out the operations described herein. Similarly, the educational product evaluation apparatus 14 will be described as a computer with memory containing for example a database containing business goal rule data 18. The computer also has memory containing executable instructions that when executed cause one or more processing devices in the computer to operate as an educational product analyzer 20 as described herein. Processing devices may include, but are not limited to, micro-processors, micro-controllers, digital signal processors (DSPs), state machines, discrete logic or any suitable combination of hardware, software and firmware. However, it will be recognized at the educational product evaluation apparatus 14 may be implemented using any suitable structure, including but not limited to a web server, or a plurality of distributed processing devices, any suitable hardware, software, firmware or any suitable combination thereof.

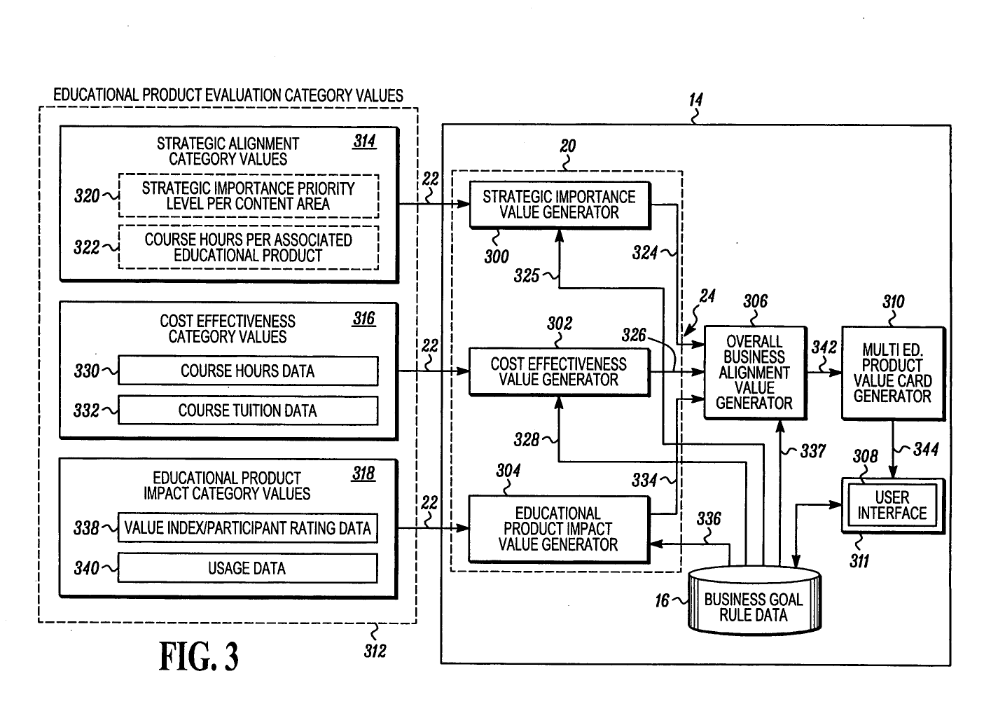

The learning management system 12 may, in one embodiment, be a conventional learning management system that stores educational product evaluation category data, such as data representing a participant's rating score for a given educational product, the tuition associate with a given educational product, the hours associated with an educational product, and any other suitable educational product evaluation category data as will be recognized by one of ordinary skill in the art, this information may be entered through a suitable user interface presented to an operator. As illustrated, the educational product evaluation apparatus 14 obtains a plurality of educational product evaluation category values 22 from the learning management system 12 or other source. The learning management system 12 and the educational product evaluation apparatus 14 are suitably coupled through a network, bus, software links, or in any other suitable fashion. The educational product analyzer 20 is preferably implemented as a software module executing from memory as executed by a processing device associated with the educational product evaluation apparatus 14. However, any suitable structure may be used. Further examples of multiple educational product evaluation category values 22 are shown in FIG. 3.

The educational product analyzer apparatus 14 stores business goal rule data 18 in a database or other suitable storage structure. Business goal rule data 18 may be for example any suitable data that represents business goals of an organization or entity or any other suitable information against which the multiple educational product evaluation category values are compared. For purposes of illustration, the business goal rule data 18 represents data used to determine how the educational product measures against, for example, at least one of a strategic importance level, a cost effectiveness level and an educational product impact level. The educational product analyzer 20 compares the multiple category values 22 against pertinent business goal rule data 18 to generate an educational product alignment value 24. As used herein “value” may include any numerical information, text information, color coding or any other suitable information.

As shown in FIG. 2, an educational product evaluation method starts in block 200, for example, by presenting a graphic user interface to a user to suitably allow entry of requisite information. In this example, the method includes storing business goal rule data 18, as shown in block 202. This may be done for example by presenting a user interface with a list of business goal rules from which a user may select a subset. The business goal rule data 18 may represent formulas, text, tables or any other suitable information that may define business goals. The business goal rules are then stored in memory 16. Also, business goal rule data 18 may include for example a series of thresholds associated with various business goals. For example, business goal rule data 18 may include data representing a limit or threshold associated with the cost of a course in the event a maximum cost threshold is not to be exceeded.

As shown in block 204, the method includes electronically analyzing the educational product based on the stored business goal rule data. For example, the cost of a particular educational product may be compared to a cost threshold and in addition, a time period threshold also stored as business goal rule data, to compare the length of a course against a desired course length. The educational product analyzer 20, or any other suitable mechanism then generates, as shown in block 206, at least one educational product alignment value 24 based on the educational product evaluation category values 22 associated with a plurality of different evaluation categories and based on the stored business goal rule data 18. The plurality of different evaluation categories as noted above may be, for example, the cost of a particular educational product, the rating given an educational product, the number of course hours that an educational product requires, or any other suitable educational product evaluation category information. Consequently, unlike conventional learning management systems, the educational product evaluation apparatus and/or method takes into account a plurality of educational product evaluation categories and utilizes stored business goal rule data to provide an educational product alignment value associated with the educational product of interest, or group of educational products of interest.

As shown in block 208, the method includes providing the educational product alignment value 24, such as by presenting the value on a display device for an operator, printing the value for a user, audibly providing the educational product alignment value, or providing the value in any other suitable manner useful to the user. The process ends as shown in block 210 by presenting the user with additional information for entry or awaiting other instruction.

To illustrate, the educational product alignment value 24 may be a numerical value, a text description, or any other suitable representation so that a user receives an indication of the relevancy of the educational product of interest and through the value, can determine, if desired, to what degree the educational product is in alignment with pertinent business goals of an organization. For example, if the educational product alignment value represents a cost effectiveness metric for a particular educational product, the multiple educational product evaluation category values 22 may include for example the number of course hours for a given educational product and the tuition for that particular educational product. The business goal rule data 18 may include for example a cost threshold that an organization does not wish to exceed or the cost that is desired to charge or spend on educational products of a given type. Other business goal rule data may include a desired length of a course knowing, for example, that participants cannot afford to spend three days a week in courses given other job related activities. As such, a course duration limit may be provided as a business goal rule. Hence the educational product analyzer 20 determines whether the actual course length and course cost exceeds for example the cost threshold and course duration limit identified by the business goal rule data and associates, in one example, a numerical value indicating how closely the actual cost and duration matches with the desired cost and course duration.

FIG. 3 illustrates in more detail one example of the educational product analyzer 20. In this example, the educational product analyzer 20 generates a plurality of educational product alignment values as opposed to for example, one educational product alignment value 24.

The educational product analyzer 20 includes a strategic importance value generator 300, a cost effectiveness value generator 302, an educational product impact value generator 304. The educational product evaluation apparatus 14 also includes an overall business alignment value generator 306, a user interface 308, such as a graphical user interface or any other suitable interface, and a multi-educational product summary generator 310. As is known in the art, user interface 308 in the instance where it is a graphical user interface is displayed on a suitable display 311, to allow a user to enter and view information as further described herein. The educational product evaluation apparatus 14 in this example is implemented as one or more suitably programmed processing devices and associated memory and as such, the educational product evaluation apparatus 14 is shown to include a plurality of functional blocks illustrating software module operations carried out by one or more suitably programmed processing devices. Such processing devices may include, but are not limited to, digital signal processors, micro-controllers, microprocessors, application specific integrated circuits, discrete logic, or any suitable combination of hardware, software, or firmware as desired. The software may be stored in any suitable storage medium such as, but not limited to, RAM, ROM, CD-ROM, EEPROM, or other optical or magnetic storage devices, and may be memory that is local to a processing device, contained within the processing device, may be distributed memory among a plurality of other devices, may be accessible via networks, included but not limited to, the internet, intranets, or any other suitable link. As such, the memory contains the software modules which are executable instructions which when executed by one or more processing devices causes the one or more processing devices to carry out the operations as described herein.

As shown in this example, the educational product evaluation system 10 presents the user with a suitable interface to enter or obtain strategic alignment category values 314, cost effectiveness category values 316, and educational product impact category values 318. However, it will be recognized that the interface may also be user interface 308 and that the educational product evaluation category data 312 may be stored in the memory containing the business goal rule data or may be in separate memory or may come from any other suitable source.

In this example, the strategic alignment category values 314 include a received priority level of an educational subject category such as a priority level per content area. A content area may be for example, an educational subject area to which individual courses are assigned. Content areas may include, but are not limited to for example, information technology, finance and accounting, procurement, customer contact, or any other suitable content areas that a curricula is designed to provide. In this example, the strategic alignment category values include strategic importance priority level data 320 that represents the strategic priority level for a particular content area. For example, a user may enter a priority level such as a high, medium, or low priority level for a particular content area in view of desired business goals. The strategic alignment category values 314 in this example, also include data representing course hours per each educational product associated with the particular educational content area designated as course hour data 322. The strategic importance priority level data 320 and the course hour data 322 serves as the plurality of educational product evaluation category values that are obtained by the strategic importance value generator 300 to generate a strategic importance alignment value 324. The strategic importance value generator 300 generates the strategic importance alignment value 324 using corresponding business goal rule data 325

The cost effectiveness value generator 302 generates a cost effectiveness alignment value 326 based on associated cost effectiveness category values 316 and based on associated business goal rule data 328. In this example, the cost effectiveness category values 316 include course hour data 330 for each educational product. For example, if a course is an 8-hour course, the course hour data 330 would represent 8 hours. The cost effectiveness category values 316 also include course tuition data 332 for the same educational product of interest. The cost effectiveness alignment value is generated based on the number of hours per educational product and a cost of the educational product, in this example, and pertinent business goal rule data 328.

The educational product impact value generator 304 generates an educational product impact alignment value 334 based on a plurality of associated educational product impact category values 318 and based on associated business goal rule data 336. In this example, the educational product impact category values 318 includes data representing participant ratings or other educational product impact information. In this example, the educational product impact alignment value 334 is based on participant rating data 338, usage data 340 associated with the particular educational product of interest and associated business goal rule data.

The overall business alignment value generator 306 is operably coupled to the strategic importance generator, the cost effectiveness generator and the educational product impact generator, to receive the respective strategic import alignment value 324, the cost effectiveness alignment value 326, and the educational product impact alignment value 324 to produce therefrom, on a per educational product basis, an overall business alignment value 342. The overall business alignment value 342 is used by the multi educational product summary generator 310 to generate an educational product summary 344 which may be for example a type of score card containing overall business alignment values 342 for a plurality of educational products of interest. The educational product summary 344 may be suitably displayed through the user interface 308 on display 311, may be printed, or otherwise presented for use by a user.

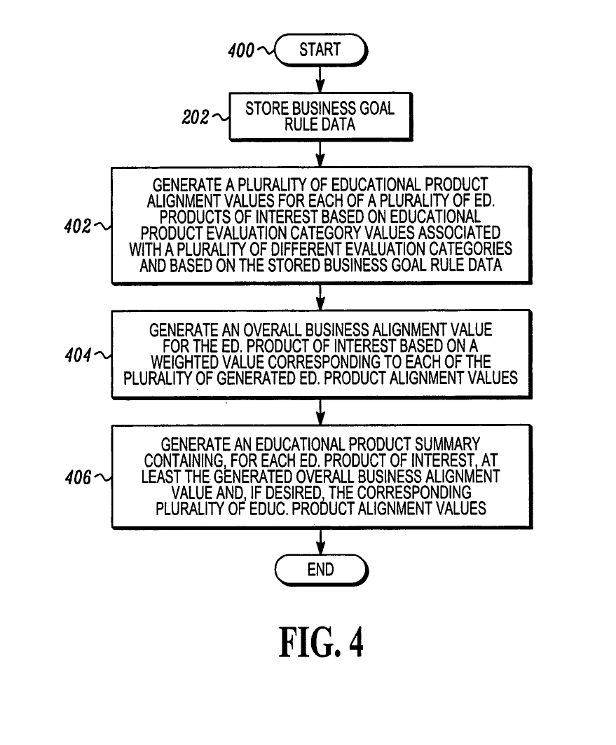

FIG. 4 illustrates one example of an educational product evaluation method carried out for example by the educational product analyzer 20. However, it will be recognized that any suitable structure may carry out the below described process and that the order of the steps described herein may be varied to accommodate any suitable desired operation. As shown in block 400, the method starts by for example, allowing the user to enter any needed business goal rule data (e.g., desired thresholds) through a suitable user interface or obtain the business goal rule data from any suitable source such memory or any other suitable source. As shown in block 402, the method includes generating a plurality of educational product alignment values, such as the strategic importance alignment value 324, the cost effectiveness alignment value 326, and the educational product impact value 334. This may be done, for example, by the educational product analyzer 20 and is generated for each educational product of interest. The plurality of educational product alignment values are based on educational product evaluation category values 312 and associated stored business goal rule data 325, 328, and 336, respectively. As shown in block 404, the method includes generating the overall business alignment value 342 based on a weighted value corresponding to each of the plurality of generated educational material alignment values 324, 326, and 334. For example, the educational product analyzer 20 may present a user interface to allow a user to assign an associated weight represented as 337 for each of the educational product alignment values. In this example, a user may assign a weight to be applied to each of the strategic importance alignment value 324, the cost effectiveness alignment value 326 and the educational product impact value 334.

As shown in block 406, the method includes generating the educational product summary, such as a form, template, or other visual indication, containing at least the overall business alignment value for each of the plurality of educational products. The overall business alignment value for each of the plurality of educational products represents how a particular educational product compares with defined business goals of an organization.

As noted above, storing business goal rule data in the business goal rule data memory may include for example storing data representing rules defined for a plurality of desired business goals wherein for example, the business goal rule data represents at least one of a strategic importance level, a cost effectiveness level and an educational product impact level.

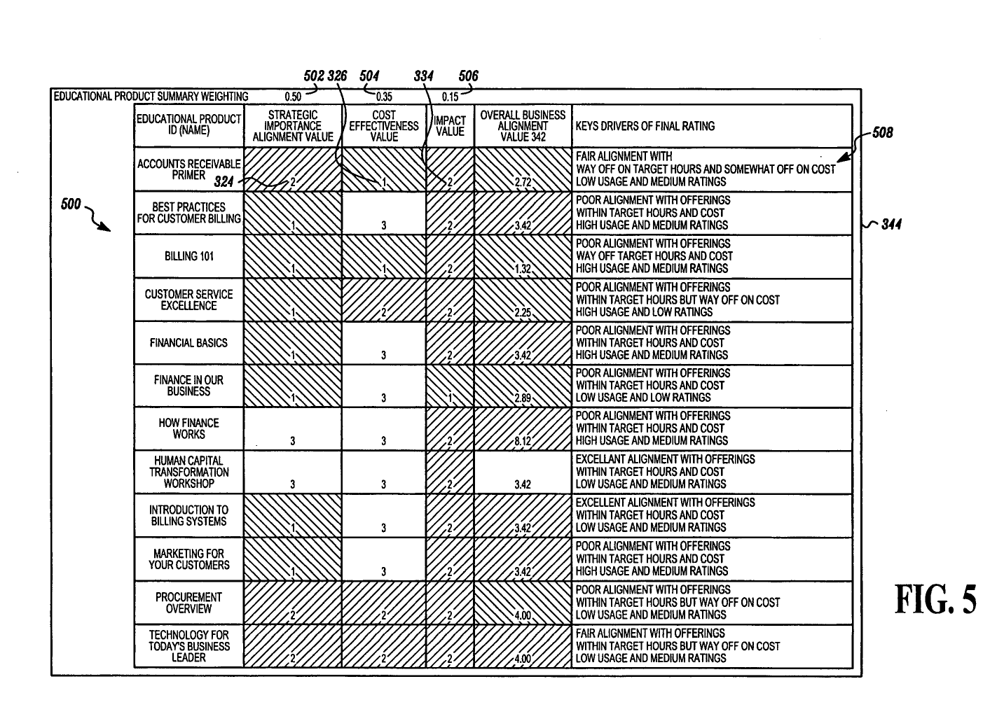

FIG. 5 illustrates one example of an educational product summary 344 in accordance with one embodiment of the invention. In this example, the educational product summary 344 is a graphic form presented on the display 311. The multi-educational product summary generator 310 generates the educational product summary 344 to contain the plurality of educational product alignment values as shown here to be the strategic importance alignment value 324, the cost effectiveness alignment value 326 and the educational product impact alignment value 334. These educational product alignment values 324 are represented, in this example, both numerically and through a visual coding in the form of a color coding.

For example, an educational product alignment value of “1” may be represented as red and an educational product alignment value equal to “2” is represented as yellow and a educational product alignment value equal to “3” is represented by the color green. However, it will be recognized that any suitable visual coding may be used. The educational product alignment values correspond to each of a plurality of educational products 500 that are identified by educational product identifiers such as educational product names. As such, the educational product summary 344, in this example, is a table generated containing the educational product alignment values of each of the plurality of educational products of interest, along with the overall business alignment value 342 associated with each educational product of interest. The overall business alignment value 342 again is also represented numerically in this example and, it is also visually coded. However, it will be recognized that either or both techniques may be used, or any other suitable technique may be used. The educational product summary 344 also includes the weight values 337 shown as weighting values 502, 504 and 506 that are received for example by the educational product evaluation apparatus 14 through suitable user input and applied to each of the educational product alignment values. The educational product summary 344 contains visually coded representations of the strategic importance alignment value 324, the cost effectiveness alignment value 326, and the educational product impact alignment value 334. The overall business alignment value 342 is generated based on the received weighting values 502, 504 and 506 associated with each of the cost effectiveness alignment value 326 and the educational product impact alignment value 334 and a strategic importance alignment value 324.

The educational product summary 344 in this example, also includes, for each educational product of interest, corresponding description data 508 that provides comment by describing a level of each associated strategic importance alignment value 324, cost effectiveness alignment value 326 and educational product impact alignment value 334. In this example, the “accounts receivable primer” educational product is designated as having a fair alignment with a company's content areas of interest. The description data 508 also indicates for the same educational product that the cost effectiveness of this educational product is far from the number of desired hours (e.g., business rule data) and somewhat off on the desired cost (e.g., business rule data) for such a course. This is based on the cost effectiveness alignment value. Additional description data 508 corresponding to the educational product impact alignment value indicates that the educational product of interest has a low usage and medium participant ratings. As such, not only are educational product alignment values provided, but corresponding description data 508 further adding comment to the values is also provided for an effective and efficient mechanism for providing useful evaluation information and determining a value of a particular educational product in view of stored business goal rule data.

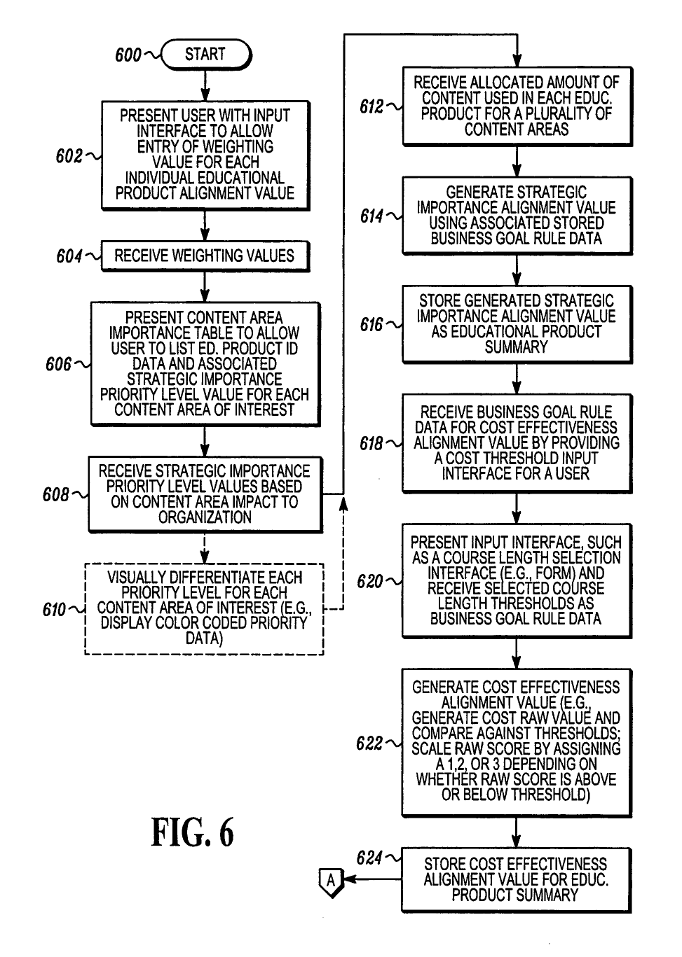

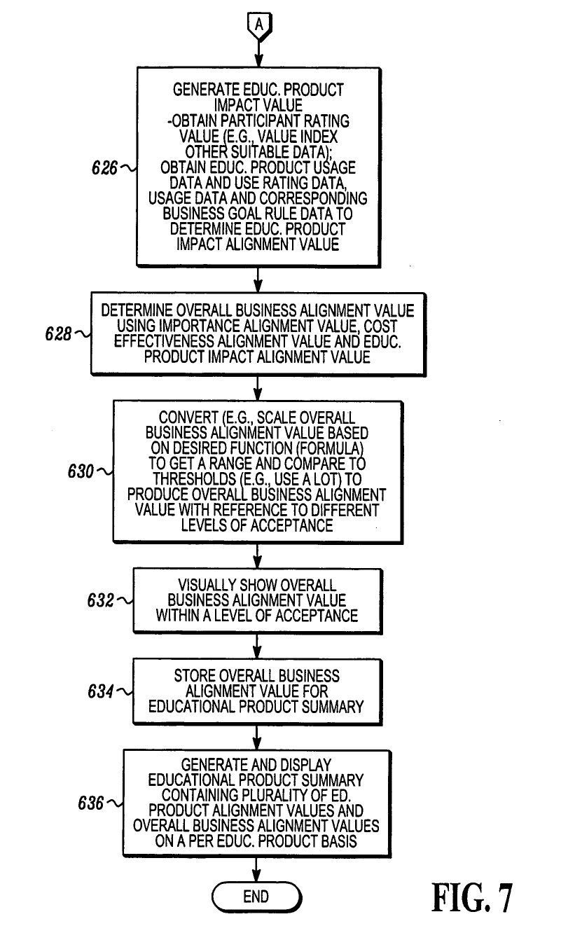

Referring to FIGS. 6-18, an educational product evaluation method and corresponding user interfaces and output information will be described in accordance with one embodiment of the invention. The method described with reference to FIGS. 6 and 7 is preferably carried out by the educational product evaluation apparatus 14. However, it will be recognized that the various steps may be performed by a distributed system, including portions performed by a web server, other servers, peers or any other suitable devices or portions of devices as desired.

As shown in block 600, the method begins by allowing a user to log on to the educational product evaluation apparatus 14. As shown in block 602, the method includes presenting a user with a weighting value input interface for each individual educational product alignment value.

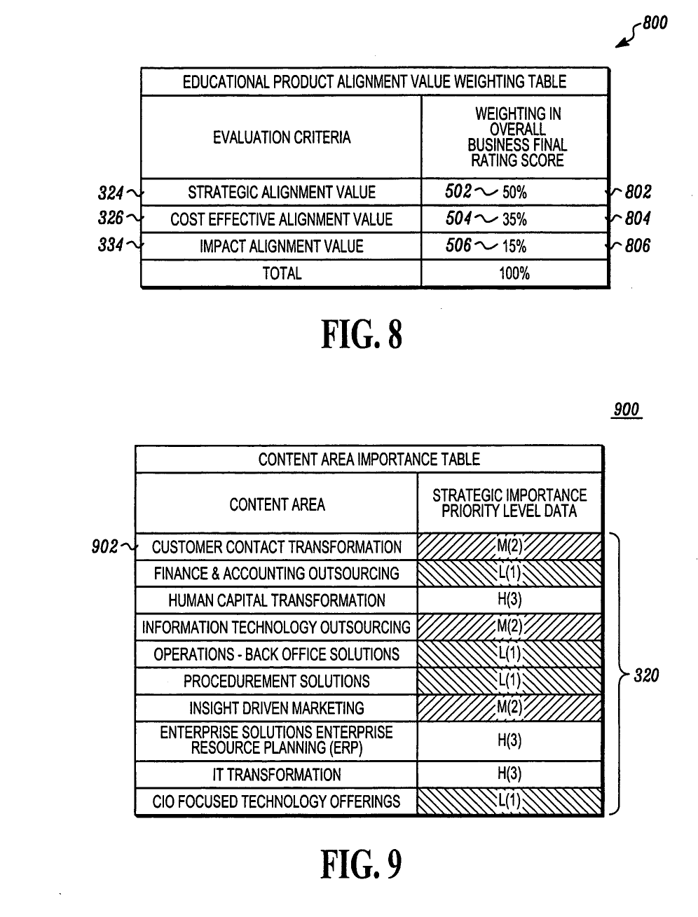

For example, as shown in FIG. 8, a weighting value input interface 800 may be presented in the form of an educational product alignment value weighting table which includes input fields 802, 804, and 806 for population by a user to designate weighting values 337 associated with each of a plurality of educational product alignment values such as the strategic importance alignment value 324, the cost effectiveness value 326, and the educational product impact alignment value 334. As shown in this example, the weighting values 337 are represented as percentages that are used to weight each educational product alignment value when generating the overall business alignment value 342.

As shown in block 604, the method includes receiving the weighting values and storing the weighting values for use by the overall business alignment value generator. These weighting values may be stored in any suitable location, including the business goal rule memory if desired. It will also be recognized that default weighting values may also be used so that no weighting value input interface may be necessary.

As shown in block 606, the method includes generating and presenting a content area importance table 900 (see FIG. 9) that visually differentiates each strategic importance priority level data 320 for each educational content area 902 of interest. The content area importance table may be a user interface to allow the user to input associated priority level data 320 to designate for example the relative strategic importance of a particular subject category that a corporate entity may wish to provide. In this example, the content area importance table 900 visually differentiates the strategic importance priority level data either numerically or through visual coding such as color coding. In this example, a medium level importance may be assigned for example a numerical value 2 or may be shown as having a yellow coding. A low strategic importance level may be designated with a numerical 1 and/or a red color coding, while a high strategic importance priority level may be designated as a numerical 3 and/or a green color coding. The strategic importance priority level data is used to compute the strategic importance alignment value.

As shown in block 608, the educational product evaluation apparatus 14 receives the strategic importance priority level data 320 as input by the user. Once received, as shown in block 610, the educational product evaluation apparatus 14 may update the content area importance table 900 to visually differentiate the strategic importance priority level data for each content area. This is shown as also optionally being done if desired by virtue of the dashed lines.

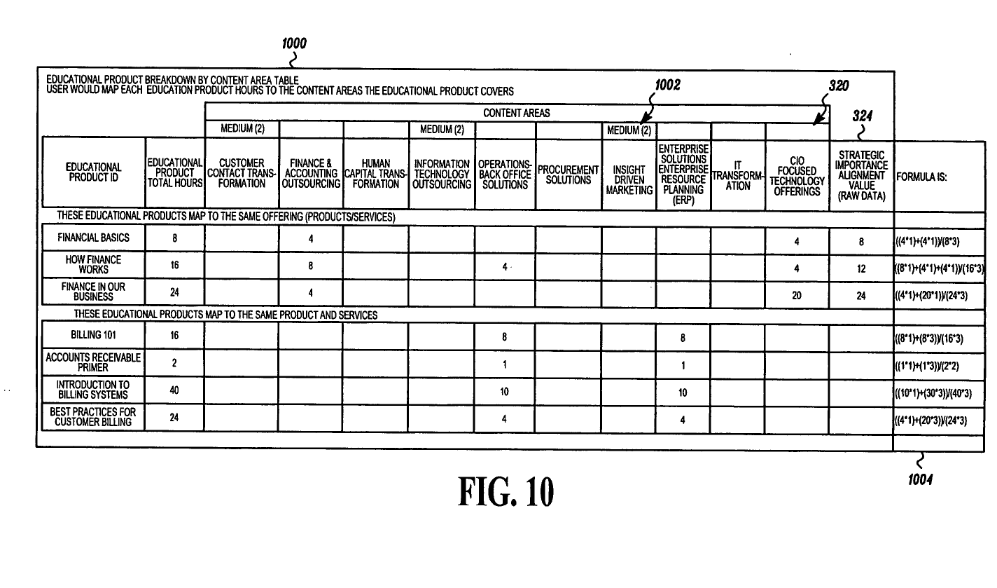

As shown in block 612, the method includes receiving (e.g., after entry by a user) allocated amounts of an educational product is allocated for each of the plurality of differing content areas, such as course hours for educational products associated with a plurality of different educational content areas for use in determining the strategic importance alignment value. One mechanism used to receive this information is shown in FIG. 10.

FIG. 10 illustrates a graphic user interface in the form of an educational product breakdown by content area table 1000. The educational product breakdown by content area table 1000 includes data representing the various content areas of interest shown generally as 1002, as well as the educational product identifier (ID). In this particular example, the educational product breakdown by content area table 1000 may be used to allow a user to enter the number of hours within each educational product that covers the different content areas. The strategic importance alignment value 324 is dynamically calculated as the data is entered through the use of for example a spreadsheet or any other suitable mechanism. For example, a user may type in content area, the associated number of hours that a particular educational product would be used in that content area. For example, for “financial basics,” if the total course is an 8-hour course, a user may determine that 4 hours of the course would be useful for the content area of “finance and accounting outsourcing” and that 4 hours of the financial basics course would cover the area of “CIO-focus technology offerings.” The educational product breakdown by content area table 1000 also contains the strategic importance priority level data 320 for each content area of interest.

As shown in block 614, the method includes generating the strategic importance alignment value 324 (row value or scaled value) by using the stored business goal rule data and the strategic importance category values. In this example, a simple formula is stored as the business goal rule data. The strategic importance business goal rule data in this example is a fixed rule, namely a formula used to calculate a strategic importance alignment value (a raw value) in accordance with the formula shown in FIG. 10.

For example, in this example, the strategic importance alignment value is calculated using the sum of the number of allocated hours times the content area at the strategic importance priority level (1, 2 or 3). This formula is shown in the column designated 1004. This formula is shown for purposes of illustration only and is typically not necessary to visually present to a user. It will also be recognized that any other suitable formula may be used if desired. The raw strategic importance alignment value is then normalized or converted to a statistically useful score such as a value between 1 and 3. This value may then be stored as shown for example in block 616. The stored strategic importance alignment value is then stored for presentation or inclusion in the educational product summary 344.

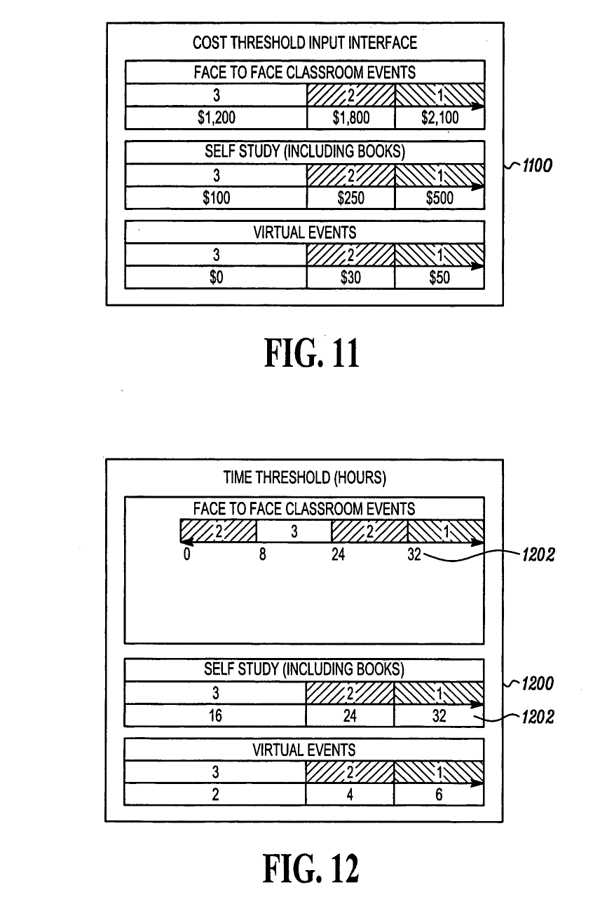

The business goal rule data 18 may include, but is not limited to, stored formulas, functions, or other relationships as desired. In addition, business goal rule data 18 may include threshold data associated with costs, or any other strategic alignment categories. In this example, as shown in block 618, business goal rule data is used to generate the cost effectiveness alignment value and may be obtained by providing a cost threshold interface. The cost threshold interface 1100 (shown in FIG. 11) is presented on the display. The cost threshold interface cost thresholds for different types of educational products. For example, different types of educational products may include face-to-face course offerings, self-study course offerings, virtual course offerings or other different types of educational products. To illustrate, a user may enter the cost thresholds for three different cost thresholds for each given educational product type as shown in FIG. 11. By way of example, for a face-to-face classroom course, a user may determine that if course tuition data 332 falls within a range of 0 up to $1,800.00, a corresponding cost score 1602 of 3 is associated therewith; whereas if a course tuition data 332 is between $1,800.00 to $2,100.00 an intermediate score of 2 is provided. The cost threshold input interface 1100 visually codes the corresponding cost score for given threshold ranges. This is done for a plurality of different types of educational products. This received business goal rule data is then stored for comparison to actual costs of educational products being evaluated.

Additional business goal rule data is also obtained for use in determining the cost effectiveness alignment value 326 as shown in FIG. 12. For example, as shown in block 620 (FIG. 6) the method includes storing the business goal rule data by providing an educational product input interface 1200 for a user, such as on the display, wherein the input interface is adapted to receive time threshold data for different types of educational products. In this example, time threshold data may, for example, include any educational product having course hours data 330 with more than 32 hours designates a high time commitment score 1204 of 1, whereas an educational product with 24-32 hours designates a medium score and so on. Hence, the time threshold data 1202 is received by the educational product evaluation apparatus 14 and stored as business goal rule data for comparison to actual course times that are being offered. The time threshold data is entered for each educational product type such as a face-to-face educational product, a self-study educational product and virtual event educational product, or any other suitable type of educational product.

In addition, if desired, the threshold input interface 1200 may also contain a bulls-eye scale indicating that the further away the threshold is set, such as the target being a score of 1, in either direction, the number will decrease effectiveness. For example, in the illustration, if an educational product is too long, people may not want to attend because they do not have the time. If the educational product length is too short, they will not come because it may not be worth the travel time. As such if the course length is less than 8 hours or more than 24 hours, a low value is assigned. Again, a formula may be stored as business goal rule data to scale the thresholds to correspond to the designated score levels of 1, 2, 3 or low, medium, high or any other suitable designation as desired.

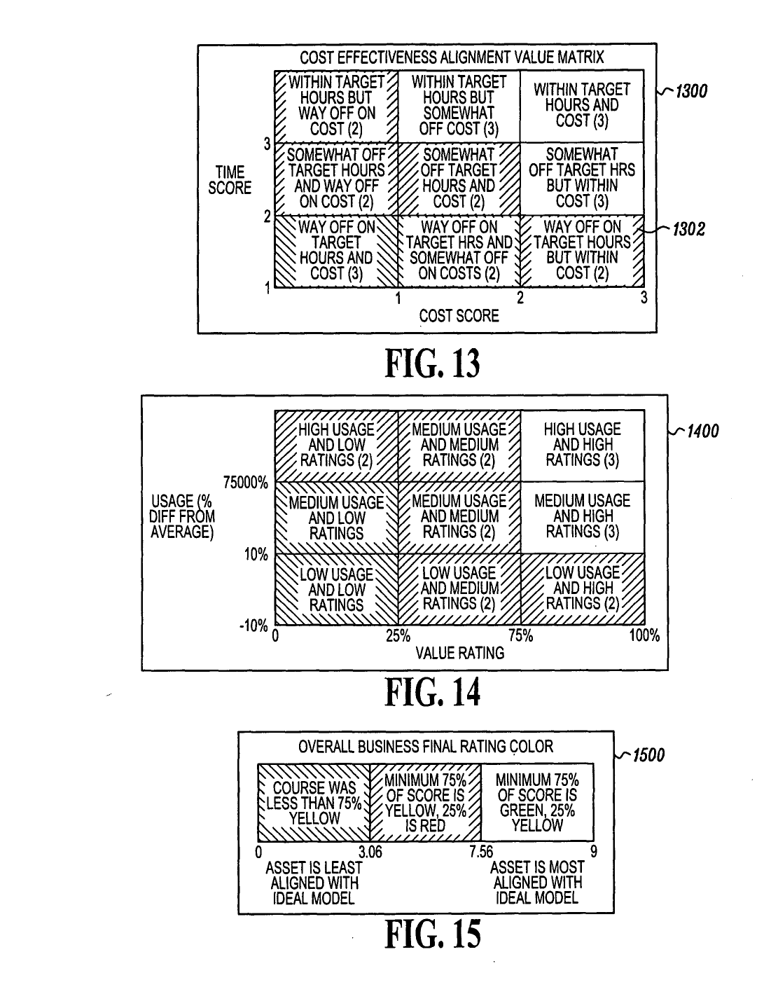

As shown in block 622, the cost effectiveness alignment value 326 is generated based on the score 1102 and 1204. The cost effectiveness alignment value 326 is generated based on a look up table (FIG. 13) that is indexed by the score 1102 and 1204. As such, the actual course hour data 330 and actual course tuition data 322 is compared to the threshold information and a low, medium or high (1, 2 or 3) value is then mapped to the educational product and becomes the cost effectiveness alignment value 326. The cost effectiveness alignment value is then stored for inclusion in the educational product summary as shown in block 624.

Also referring to FIG. 13, the method may include presenting a cost effectiveness alignment value matrix 1300 which may be visually presented or otherwise provided for a user. The cost effectiveness alignment value matrix 1300 contains at least comment data generally designated 1302 relating to different cost scores and different corresponding time scores to provide a textual comment of each cost effectiveness alignment value. As noted above, the formula in the case of determining the cost effectiveness alignment value may simply be a lookup table which, for example, may indicate that if there is a cost score of 3 and a time score of 3, that the cost effectiveness alignment value is also a 3 (shown in parenthesis in FIG. 13) indicating in this example that the actual course hours and course tuition are within the target level associated with the type of educational product. Hence, the matrix is indexed based on the scores shown in FIGS. 11 and 12.

As shown in block 626 (FIG. 7), the method also includes generating the educational material impact alignment value. In this example, the business goal rule data 8 again may be a lookup table or other mapping mechanism wherein actual participant rating data 338 and educational material usage data 340 is compared with a desired participant rating and usage information as defined by the lookup table or other mapping mechanism. For example, the business goal rule data 18 may be obtained by providing a user interface that receives a desired usage level, or for example, an average usage level for a educational product as well as a desired participant rating threshold. Alternatively, the participant rating may be scaled on a percentage basis and normalized to provide an indication of where a particular actual participant rating falls within a range of other rating information. Any suitable educational material impact category values may be used, as well as any suitable business goal rule data. In this example, the participant rating data 338 is obtained from the learning management system or any other suitable source, as well as the usage data 340. The usage data 340 is compared to an average threshold such as that entered by a user. The participant rating data 338 is prepared, for example, by normalizing all product rating onto a scale of 1-100.

As shown in FIG. 14, the method may include presenting an educational product impact matrix 1400 which includes impact comments for different value ratings and different usage levels. Again, the matrix 1400 defines the educational product impact alignment value by mapping the received participant rating data 338 and usage data 340 against that of corresponding thresholds. As shown, for example, an educational product impact alignment value 334 equal, for example, to a “1” rating may be assigned to those educational products having a value rating in the lower 25% and a usage difference from an average threshold usage value of less than 10% may be indicated as a low usage and low rating.

The generated strategic importance alignment value 324, the cost effectiveness alignment value 326, and the educational product impact alignment value 334 are then used to generate an overall business alignment value 342. This may done, for example, based on the following formula: (strategic importance alignment value×weighting value)+(cost effective alignment value×weighting value)+(impact alignment value×weighting)=overall business alignment value. This is shown for example in block 628. Once the overall business alignment value is determined for each educational product of interest, the value may be converted if necessary (such as scaled by squaring the sum of products or other suitable scaling/normalizing function) based on a desired function or formula to get a range suitable for presentation. This is shown for example in block 630.

For example, as shown in FIG. 15, the educational product evaluation apparatus may generate an overall business alignment value range graphic element 1500 containing sub-ranges corresponding to different degrees of alignment with corresponding business goal rule data. For example, the overall business alignment value 342 is calculated by using the weighted average of the impact alignment value, strategic importance alignment value, and cost effectiveness alignment values. The value 342 is then squared to create a greater spread across individual educational products. The overall business alignment value is then mapped against the illustrated table to determine a final color and score. Hence, the raw overall business alignment value is shown in FIG. 15.

As shown in block 632, the method includes visually showing or otherwise presenting, such as by printing, the overall business alignment score within a level of acceptance as shown for example in FIG. 15. The overall business alignment value is then stored for display in the educational product summary as shown in block 634. The method, as shown in block 636, includes generating and displaying the educational product summary which contains the individual educational material alignment values and overall business alignment value on a per educational product business.

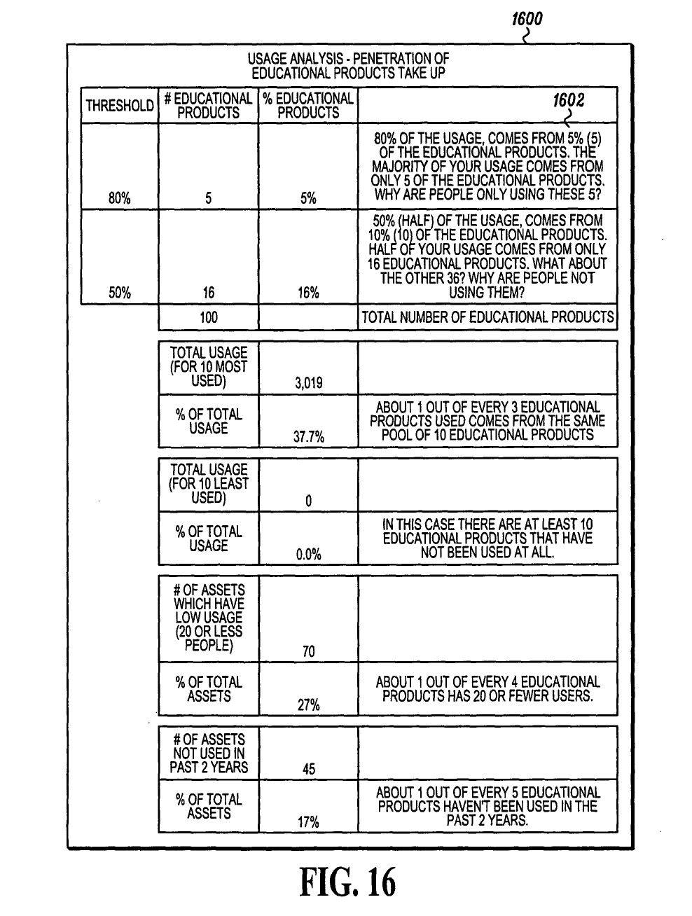

In addition, the educational product evaluation apparatus may also provide additional information which further enhances a user's ability to evaluate a curricula and its educational product components. For example, as shown in FIG. 16, a usage analysis table 1600 serves as a graphic element illustrating educational product penetration compared to a group of educational products. As shown, the graphic element 1600 may be used to indicate for example that only 5 educational products account for 80% of total participant usage. This may be based on, for example, the usage data 340 and business goal rule data such as the 80% threshold or any other suitable information. Comment data 1602 corresponding to each threshold is also provided to provide efficient feedback to identify how much penetration a particular product may have within a group of educational products. The penetration is an evaluation of educational products across all interest.

FIG. 17 illustrates one example of a strategic coverage graphic which illustrates for example how an entity's educational products, based on hours, mapped to content area of strategic importance. For example, the strategic alignment category values are used in this example to illustrate that 55% of the total number of hours mapped to content areas which are of low strategic importance. This is determined based on the priority level data 320 and based on the course hours per priority level content area.

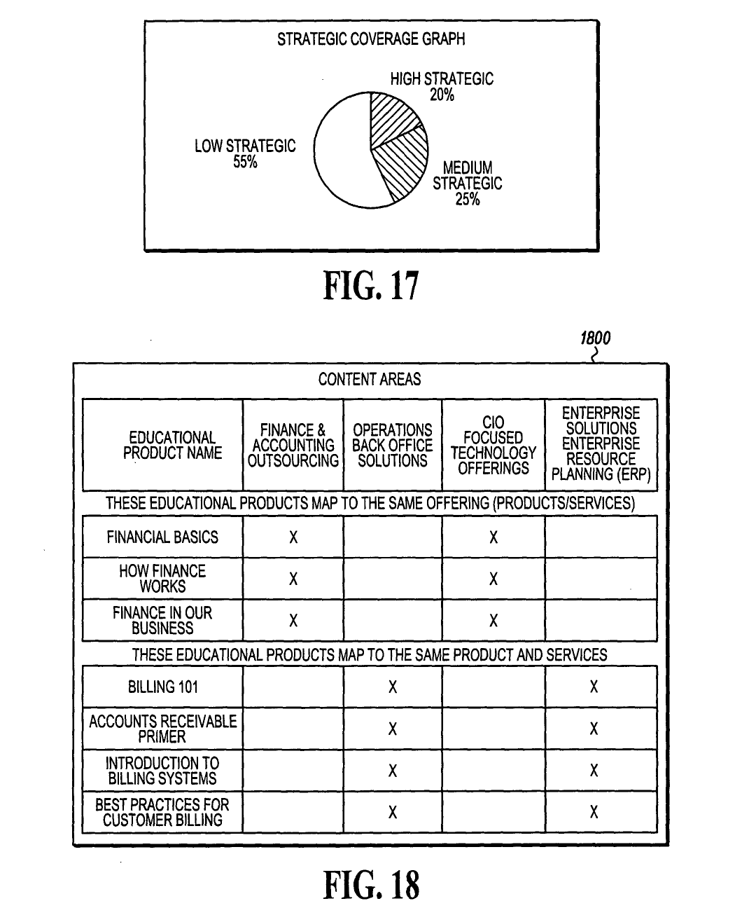

FIG. 18 illustrates the method including generating an educational product content redundancy map 1800 that indicates which educational products include subject matter that is pertinent to multiple strategic subject categories. The educational product content redundancy map 1800 includes the educational product IDs and selected content areas. This is an educational product breakdown by strategic category or a strategic content area. For example, the “Financial Basics” course contains subject matter useful for the finance and accounting outsourcing content area as well as the CIO-Focused Technology offering area as do other courses shown, showing that the courses may be redundant. This is also based on the information shown in FIG. 10.

Hence, an apparatus and method as described herein utilizes a plurality of strategic alignment category values that may be obtained through the educational product evaluation apparatus, or from any other suitable source (such as a Learning Management System) and are used to determine one or more educational product alignment values such as a strategic importance alignment value, a cost effectiveness alignment value, and an educational product impact alignment value. These educational product alignment values are combined and used to determine an overall business alignment value for each educational product of interest. The educational product alignment values are determined based on stored business goal rule data so that the resulting overall business alignment value can represent how well a particular educational product fits within an organization's strategic design. Other advantages will be recognized by those of ordinary skill in the art.

It will be recognized that the disclosed processes may be performed by any suitable device or a plurality of devices and, if desired, using one or more networks including the Internet, an intranet or any other suitable networks.

In the foregoing specification, the present invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential features or elements of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. An educational product evaluation method comprising:
storing business goal rule data; and
analyzing the educational product based on the stored business goal rule data.

2. The method of claim 1 wherein analyzing the educational product includes generating at least one educational product alignment value for the educational product based on plurality of educational product evaluation category values and the stored business goal rule data.

3. The method of claim 1 wherein storing the business goal rule data includes storing data representing rules defined for a plurality of desired business goals wherein the business goal rule data represents data used to determine how the educational product measures against at least one of: a strategic importance level, a cost effectiveness level and an educational product impact level.

4. The method of claim 1 including presenting the educational product alignment value for a user.

5. An educational product evaluation method comprising:
storing business goal rule data;
generating a plurality of educational product alignment values for each of a plurality of educational products, based on a plurality of associated plurality of educational product evaluation category values and the stored business goal rule data;
generating, for each educational product of interest, an overall business alignment value based on the plurality of educational product alignment values; and
generating an educational product summary containing at least the overall business alignment value for each of the plurality of educational products.

6. The method of claim 5 wherein storing the business goal rule data includes storing data representing rules defined for a plurality of desired business goals wherein the business goal rule data represents at least one of: a strategic importance level, a cost effectiveness level and an educational product impact level.

7. The method of claim 5 including generating the educational product summary to contain the plurality of educational product alignment values corresponding to each of the plurality of educational products.

8. The method of claim 7 including presenting the educational product summary for a user.

9. The method of claim 5 including generating the plurality of educational product alignment values for each of a plurality of educational products based on received weighting values associated with each of the plurality of educational product alignment values.

10. The method of claim 5 wherein generating the plurality of educational product alignment values for each of a plurality of educational products includes generating a strategic importance alignment value, a cost effectiveness alignment value and an educational product impact alignment value.

11. The method of claim 10 wherein the strategic importance alignment value is based on a strategic importance priority level data of an educational content area and on at least course hours for the educational products associated with the educational content area; the cost effectiveness alignment value is based on at least a number of ours per educational product and a cost of the educational product; and the educational product impact alignment value is based on at least participant rating data and usage data associated with the educational product.

12. The method of claim 11 including presenting a content area importance table that visually differentiates each strategic importance priority level data for each educational content area.

13. The method of claim 5 wherein storing the business goal rule data includes providing a cost threshold input interface operative to receive cost thresholds for different types of educational products.

14. The method of claim 5 wherein storing the business goal rule data includes providing an educational product time input interface operative to receive time threshold data for different types of educational products.

15. The method of claim 10 including generating a cost effectiveness alignment value matrix containing at least description data relating to different cost scores and different corresponding time scores.

16. The method of claim 7 including generating the education product summary to include corresponding description data for each educational product and for each educational product alignment value for each educational product.

17. The method of claim 5 including generating an overall business alignment value range graphic element containing sub ranges corresponding to different degrees of alignment with corresponding business goal rule data.

18. The method of claim 5 including generating a graphic element illustrating educational product penetration compared to a group of educational products.

19. The method of claim 5 including generating an educational product content redundancy map indicating which educational products include subject matter that is pertinent to multiple strategic subject categories.

20. The method of claim 10 wherein generating the educational product summary includes providing a graphic element representing the educational product summary including visual coding of the strategic importance alignment value, the cost effectiveness alignment value and the educational product impact alignment value.

21. An educational product evaluation method comprising:
storing business goal rule data;
generating a plurality of educational product alignment values, for each of a plurality of educational products wherein the educational products include educational courses, based on a plurality of associated plurality of educational product evaluation category values and the stored business goal rule data;
storing each of the plurality of educational product alignment values;
generating, for each educational product of interest, an overall business alignment value based on the plurality of stored educational product alignment values;
generating an educational product summary containing at least the overall business alignment value for each of the plurality of educational products and the plurality of stored educational product alignment values that include: a strategic importance alignment value, a cost effectiveness alignment value and an educational product impact alignment value; and
wherein the strategic importance alignment value is based on strategic importance priority level data of an educational content area and on at least course hours for the educational products associated with the educational content area; the cost effectiveness alignment value is based on at least a number of ours per educational product and a cost of the educational product; and the educational product impact alignment value is based on at least participant rating data and usage data associated with the educational.

22. The method of claim 21 including presenting a content area importance table that visually differentiates each strategic importance priority level data for each educational content area.

23. The method of claim 22 wherein storing the business goal rule data includes providing a cost threshold input interface operative to receive cost thresholds for different types of educational products.

24. The method of claim 23 wherein storing the business goal rule data includes providing an educational product time input interface operative to receive time threshold data for different types of educational products.

25. The method of claim 24 including generating a cost effectiveness alignment value matrix containing at least description data relating to different cost scores and different corresponding time scores.

26. The method of claim 25 including generating the education product summary to include corresponding description data for each educational product and for each educational product alignment value for each educational product.

27. The method of claim 21 including generating an overall business alignment value range graphic element containing sub ranges corresponding to different degrees of alignment with corresponding business goal rule data.

28. The method of claim 21 including generating a graphic element illustrating educational product penetration compared to a group of educational products.

29. The method of claim 21 including generating an educational product content redundancy map indicating which educational products include subject matter that is pertinent to multiple strategic subject categories.

30. The method of claim 21 wherein generating the educational product summary includes providing a graphic element representing the educational product summary including visual coding the strategic importance alignment value, the cost effectiveness alignment value and the educational product impact alignment value.

31. An educational product evaluation apparatus comprising:
at least one processing device; and
memory containing executable instructions that when executed by the at least one processing device, causes the at least one processing device to:
store business goal rule data; and
generate at least one educational product alignment value for the educational product based on plurality of educational product evaluation category values and the stored business goal rule data.

32. The apparatus of claim 31 wherein the stored business goal rule data represents rules defined for a plurality of desired business goals wherein the business goal rule data represents data used to determine how the educational product measures against at least one of: a strategic importance level, a cost effectiveness level and an educational product impact level.

33. The apparatus of claim 31 including a display operatively coupled to the at least one processing device, and wherein the at least one processing device controls presentation of the educational product alignment value on the display for a user.

34. An educational product evaluation apparatus comprising:
at least one processing device; and
memory containing executable instructions that when executed by the at least one processing device, causes the at least one processing device to:
store business goal rule data, provide plurality of educational product evaluation category values;
generate a plurality of educational product alignment values for each of a plurality of educational products, based on a plurality of associated plurality of educational product evaluation category values obtained from the plurality of educational product evaluation category values source and the stored business goal rule data, and
generate, for each educational product of interest, an overall business alignment value based on the plurality of educational product alignment values; and to generate an educational product summary containing at least the overall business alignment value for each of the plurality of educational products values that include: a strategic importance alignment value, a cost effectiveness alignment value and an educational product impact alignment value; and
wherein the strategic importance alignment value is based on a strategic importance priority level data of an educational content area and on at least course hours for the educational products associated with the educational content area; the cost effectiveness alignment value is based on at least a number of ours per educational product and a cost of the educational product; and the educational product impact alignment value is based on at least participant rating data and usage data associated with the educational product.

35. The apparatus of claim 34 wherein the memory includes executable instructions that cause one or more processing devices to present a content area importance table that visually differentiates each strategic importance priority level data for each educational content area.

36. The apparatus of claim 34 wherein the memory includes executable instructions that cause one or more processing devices to provide a cost threshold input interface operative to receive cost thresholds for different types of educational products.

37. The apparatus of claim 34 wherein the memory includes executable instructions that cause one or more processing devices to provide an educational product time input interface operative to receive time threshold data for different types of educational products.

38. The apparatus of claim 34 wherein the memory includes executable instructions that cause one or more processing devices to generate a cost effectiveness alignment value matrix containing at least description data relating to different cost scores and different corresponding time scores.

39. A storage medium comprising:
memory containing executable instructions that when executed by the at least one processing device, causes the at least one processing device to:
store business goal rule data, provide plurality of educational product evaluation category values;
generate a plurality of educational product alignment values for each of a plurality of educational products, based on a plurality of associated plurality of educational product evaluation category values obtained from the plurality of educational product evaluation category values source and the stored business goal rule data, and
generate, for each educational product of interest, an overall business alignment value based on the plurality of educational product alignment values; and to generate an educational product summary containing at least the overall business alignment value for each of the plurality of educational products values that include: a strategic importance alignment value, a cost effectiveness alignment value and an educational product impact alignment value; and
wherein the strategic importance alignment value is based on strategic importance priority level data of an educational content area and on at least course hours for the educational products associated with the educational content area; the cost effectiveness alignment value is based on at least a number of ours per educational product and a cost of the educational product; and the educational product impact alignment value is based on at least participant rating data and usage data associated with the educational.

40. The storage medium of claim 39 wherein the memory includes executable instructions that cause one or more processing devices to present a content area importance table that visually differentiates each strategic importance priority level data for each educational content area.

41. The storage medium of claim 39 wherein the memory includes executable instructions that cause one or more processing devices to provide a cost threshold input interface operative to receive cost thresholds for different types of educational products.

42. The storage medium of claim 39 wherein the memory includes executable instructions that cause one or more processing devices to provide an educational product time input interface operative to receive time threshold data for different types of educational products.

43. An educational product evaluation apparatus comprising:
memory containing business goal rule data;
an educational product analyzer, operatively coupled to the memory, and further comprising:
a strategic importance generator operative to generate a strategic importance alignment value based on a plurality of associated strategic alignment category values and the business goal rule data;
a cost effectiveness generator operative to generate a cost effectiveness alignment value based on associated cost effectiveness category values and based on the business goal rule data;
an educational product impact generator operative to generate an educational product impact alignment value based on a plurality of associated educational product impact category values and based on the stored business goal rule data;
an overall business alignment generator operatively coupled to the strategic importance generator, the cost effectiveness generator and the educational product impact generator, and operative to generate, on a per educational product basis, an overall business alignment value based on the strategic importance alignment value, the cost effectiveness alignment value and the educational product impact alignment value; and
a multi-educational product summary generator, operatively coupled to the overall business alignment generator, and operative to generate an educational product summary containing at least the overall business alignment value for each of a plurality of educational products of interest and the strategic importance alignment value, the cost effectiveness alignment value and the educational product impact alignment value.

44. The apparatus of claim 43 wherein the educational product summary contains visually coded representations of the strategic importance alignment value, the cost effectiveness alignment value and the educational product impact alignment value.

45. The apparatus of claim 43 wherein the overall business alignment value is generated based on received weighting values associated with each of the cost effectiveness alignment value and the educational product impact alignment value.

46. The apparatus of claim 43 wherein the educational product summary contains, for each educational product of interest, corresponding description data describing a level of each associated strategic importance alignment value, cost effectiveness alignment value and educational product impact alignment value.
